(19) United States
(12) Patent Application Publication
(10) Pub. No.: US 2026/0167188 A1
(43) Pub. Date: Jun. 18, 2026

(54) SYSTEM COMPRISING A MOTOR VEHICLE AND A SERVER, AND A METHOD FOR OPERATING THE SYSTEM

(71) Applicant: VOLKSWAGEN AKTIENGESELLSCHAFT, Wolfsburg (DE)

(72) Inventors: Jonas KASTE, Alfeld (DE); Felix STAHL, Braunschweig (DE); Timur AMINEV, Braunschweig (DE)

(21) Appl. No.: 19/413,024

(22) Filed: Dec. 9, 2025

(30) Foreign Application Priority Data
Dec. 13, 2024 (DE) 10 2024 137728.3

(51) Int. Cl. B60W 30/12; B60W 30/14

(52) U.S. Cl. CPC B60W 30/12; B60W 30/143; B60W 2556/45; B60W 2720/103

(57) ABSTRACT

A method for operating a system includes a transportation vehicle and a server, wherein swarm data including data sets are provided on the server, each data set representing a path and a speed associated with the current location of the vehicle, wherein a swarm path and speed are determined based on the swarm data, wherein an identifier associated with the driver of the vehicle is determined, wherein, depending on the identifier, a target path deviation from the swarm path and/or a target speed deviation from the swarm speed is determined, wherein a target path for the vehicle is determined based on the target path deviation and the swarm path, and/or wherein a vehicle target speed determined based on the target speed deviation and the swarm speed, wherein the vehicle is automatically guided longitudinally and/or transversely depending on the target speed and/or the target path using a driver assistance system.

### PRIORITY CLAIM

This patent application claims priority to German Patent Application No. 10 2024 137 728.3, filed 13 Dec. 2024, the disclosure of which is incorporated herein by reference in its entirety.

### SUMMARY

Disclosed embodiments relate to a method for operating a system including a transportation vehicle, which has a driver assistance system for automatic longitudinal and/or transverse guidance, and a server, which includes swarm data, as well as such a system.

### BRIEF DESCRIPTION OF THE DRAWINGS

Disclosed embodiments will be described with reference to the figures. The features and feature combinations in the description, as well as the features and feature combinations presented in the figures, may be used not only in the combination respectively indicated but also in other combinations or individually, without departing from the scope of the disclosure. In the drawings:

FIG. 1 schematically shows a system comprising a transportation vehicle which has a driver assistance system for automatic longitudinal and/or transverse guidance, and a server, external to the transportation vehicle, on which swarm data is stored; and

FIG. 2 shows a flow diagram of a method sequence for operating the system.

### DETAILED DESCRIPTION

Some transportation vehicles have driver assistance systems. Such driver assistance systems are used to assist the driver in certain driving tasks and/or to assume a driving task. For example, a driver assistance system can provide a function for automatic longitudinal guidance, for example, in the context of a distance cruise control, and/or for automatic transverse guidance, for example, in the context of lane guidance along a center of a lane.

It is also known to use swarm data for driver assistance systems. Swarm data is data provided by transportation vehicles. For example, the data can represent a driven road or a location, as well as information about the road or the location. The information is determined by the transportation vehicle using a sensor and/or a camera. The information can represent, for example, the path actually driven on the road (driven lane), in particular represented by the distance from a lane marking of the road, a speed profile and/or an acceleration profile of the transportation vehicle along the driven path.

For example, the availability of an existing driver assistance system can be increased based on the swarm data. Swarm data can be used, for example, to derive data about the course (path) to be driven and to enable lane guidance according to this derived course, even in response to no lane markings being on the road that would typically be used to determine the course to be driven.

Swarm data also has the advantage that this data includes actual drives. Thus, data or variables for controlling the transportation vehicle by the driver assistance system can be determined based on the swarm data, which represent a comparatively human behavior and perceived by the driver as comparatively pleasant.

However, different drivers may have different preferences. For example, a sporty driver will perceive a different acceleration behavior to be pleasant than a driver who prefers a more fuel-efficient driving style. These different preferences can also lead to reduced driver acceptance when using swarm data for driver assistance systems.

DE 10 2021 207 781 A1 describes a method for adapting an assisted or automated driving function of a vehicle. In the method, a driving behavior of a driver of the vehicle in at least one driving situation is recorded and the recorded driving behavior of the respective driver is evaluated in order to determine an individual driving style of the respective driver. Furthermore, a special parameter set for the assisted or automatic driving function of the vehicle is determined, which effects a driving style adapted to the individual driving style of the respective driver of the assisted or automated driving function of the vehicle, and the special parameter set may be used to modify an existing parameter set of the vehicle's assisted or automated driving function.

From DE 10 2022 211 433 A1, a driver assistance system for a vehicle is known, wherein the driver assistance system is configured such that control variables and/or parameters of the driver assistance system can be defined using selectable driving profiles, wherein at least one driving profile can be selected, in which the control variables and/or parameters of the driver assistance system are determined in a position-dependent manner with the aid of swarm data.

Disclosed embodiments provide a particularly suitable method for operating a system comprising a transportation vehicle and a server. In particular, using the method, an automatic longitudinal and/or transverse guidance is intended to be adaptable and/or adapted to a driving behavior of the driver. Such a system will also be specified.

In these the comments in relation to the method apply, mutatis mutandis, also to the system, and vice versa.

The method may be used for operating a system comprising a transportation vehicle, which has a driver assistance system for automatic longitudinal and/or transverse guidance, and a server external to the transportation vehicle. This transportation vehicle of the system is also referred to below as an “ego vehicle” for better distinguishability in relation to other vehicles.

In a suitable manner, “automatic longitudinal and/or transverse guidance” is an assisting longitudinal or transverse guidance according to Level 1 of the standard SAE J3016, a partially automatic longitudinal and/or transverse guidance according to Level 2 of the standard SAE J3016, a conditionally automatic longitudinal and/or transverse guidance according to Level 3 of the standard SAE J3016, highly automatic longitudinal and/or transverse guidance according to Level 4 of the standard SAE J3016 and/or a fully automatic longitudinal and/or transverse guidance according to Level 5 of the standard SAE J3016. The same expediently applies to “automatically longitudinally and/or transversely guided”.

For example, the transportation vehicle is guided longitudinally, in particular only, using the driver assistance system, wherein the driver carries out the transverse guidance themselves. Furthermore, for example, the transportation vehicle is guided transversely, in particular only, using the driver assistance system, wherein the driver carries out the longitudinal guidance themselves. In a further example, the transportation vehicle is guided both longitudinally and transversely, in particular only, using the driver assistance system, wherein the driver, for example temporarily and/or in a situation-dependent manner, does not carry out either the longitudinal or the transverse guidance.

The driver assistance system is a driver assistance system according to Level 1 or Level 2 according to the standard SAE J3016, for example.

According to the method, swarm data is provided on the server. The swarm data, for example, was transmitted to the server in advance from a large number of transportation vehicles, for example comprising the ego vehicle, and/or was calculated based on the data transmitted by these vehicles. The swarm data includes data sets, wherein each data set represents a path and/or a speed, in particular associated with the current location of the ego vehicle. In particular, this means that the path and/or the speed itself is present in the data sets or can be determined from the data sets and become useful. The current location of the vehicle is determined in particular a navigation system and/or by GPS (Global Positioning System).

The paths of the data sets of the swarm data therefore represent a previously driven path, in particular at the location of the ego vehicle. For example, the respective path is represented by a distance from a lane marking on the road or from a roadside. For example, the path is a parameter, in particular a number, representing this distance.

The speeds of the data sets of the swarm data therefore represent a speed during a previous drive, in particular at the location of the ego vehicle and/or on the respective path. For example, the speed is a parameter, in particular a number, representing that speed.

According to the method, a swarm path and a swarm speed are determined based on the data sets, in particular based on the server. An average of the speeds of the data sets is appropriately determined as the swarm speed and an average of the paths as the swarm path.

Furthermore, an identifier assigned to the driver of the transportation vehicle is determined, in particular by the ego vehicle, expediently based on its driver assistance system. For example, an identification number of the driver is determined as the identifier. For this purpose, the identity of the driver and the identification number assigned to the driver are expediently determined. The driver, in turn, is recognized in a known manner, for example, based on facial recognition, a driver input, their fingerprint, their transportation vehicle key and/or their mobile phone.

Subsequently, depending on the identifier, a target path deviation from the swarm path and/or a target speed deviation from the swarm speed is determined, in particular calculated. A target path for the ego vehicle is determined based on the target path deviation and the swarm path. For example, the swarm path is multiplied by the target path deviation. Alternatively, the target path deviation is added to the swarm path.

In addition to or as an alternative to determining the target path, a target speed for the ego vehicle is determined, in particular calculated, based on the target speed deviation and the swarm speed. For example, the swarm speed is multiplied by the target speed deviation. Alternatively, the target speed deviation is added to the swarm speed.

The transportation vehicle (ego vehicle) is then automatically guided longitudinally and/or transversely using the driver assistance system depending on the target path and/or depending on the target speed. Expediently, in this process the driver assistance system controls a brake, a traction drive, and/or a steering of the transportation vehicle such that the transportation vehicle travels at the target speed and/or on the target path.

In summary, an automatic longitudinal and/or transverse guidance of the transportation vehicle takes place using the driver assistance system depending on the identifier and, thus, in a driver-specific manner. In this way, an automatic longitudinal and/or transverse guidance can be adapted and/or is adapted to the driver. This is optionally accompanied by an increase in the acceptance of driving using the driver assistance system.

According to at least one embodiment of the method, the current driving situation of the ego vehicle is determined. For the determination of the current driving situation, a descriptor, i.e., a characteristic parameter and/or a property, of the ego vehicle, a descriptor of the vehicle environment, a descriptor of the driver, a descriptor of a planned or currently driven route, and/or a descriptor of the road are expediently used. For example, a descriptor of the ego vehicle is a vehicle category such as a small car or a bus, an engine type such as a combustion engine or an electric transportation, a residual range, a load, the number of occupied seats, or a selected driver profile such as “Sport” or “Comfort”. Further, for example, a descriptor of the vehicle environment is the light conditions, the weather, or the traffic density. Further, for example, a descriptor of the driver is his/her age, gender or driving distance per year. Further, for example, a descriptor of the planned or currently driven route is a length of the route, a time spent by the driver in the ego vehicle, a permitted maximum speed, a road category such as a country road, city road or motorway, or taking a bend. Further, for example, a descriptor of the road is a condition of the road, a width of the road, a road material such as tar or gravel or paving stones.

The descriptors are each, for example, predefined or predefinable, in particular by input from the driver. Alternatively, the descriptors are determined based on sensor data of a sensor of the ego vehicle. For example, image data from an external camera of the ego vehicle is evaluated in order to determine a property of the vehicle environment and/or the road.

The current driving situation is, thus, expediently described using descriptors, wherein the descriptors each describe a fact that influence and/or can influence the manual and/or automatic driving of the transportation vehicle. An example of a driving situation is “cornering at night on wet ground with low traffic density on a country road”.

Furthermore, in this embodiment of the method, the target path deviation and/or the target speed deviation is determined depending on the current driving situation. In summary, the target path deviation and/or the target speed deviation is determined depending on the current driving situation and depending on the identifier.

According to a suitable embodiment, the current driving situation is first classified for the determination of the target path deviation and/or the target speed deviation. In other words, the current driving situation is assigned to one of a plurality of predefined classes. This assignment is expediently performed depending on the descriptors.

The value (i.e., its magnitude and its sign) of the target path deviation and/or the value of the target speed deviation is then assigned to the class specified during the classification. In other words, the value of the target path deviation and/or the value of the target speed deviation is in turn assigned to the class assigned to the current driving situation. In this process the value of the target path deviation assigned to the class and/or the value of the target speed deviation assigned to the class depends on the identifier.

Appropriately, a characteristic curve or a characteristic map may be used to determine the target path deviation and/or the target speed deviation. This characteristic curve or map assigns the target path deviation and/or the target speed deviation to the descriptors (or in analogous manner, to the current driving situation determined based on these) and the identifier.

Alternatively, a support vector machine (SVM) may be used to determine the target path deviation and/or the target speed deviation. It is expedient to classify the current driving situation using the support vector machine. The target path deviation and/or the target speed deviation are then assigned to the driving situation classified in this way. For example, a table or a characteristic curve or map is used.

Alternatively, a decision tree may be used to determine the target path deviation and/or the target speed deviation. It is expedient to classify the current driving situation using the decision tree. In this case, a descriptor of the ego vehicle, the vehicle environment, the driver, a planned or currently driven route, and/or the road is expediently queried at each node of the decision tree, wherein the so-called leaf of the tree defines the class. The target path deviation and/or the target speed deviation are then assigned to the driving situation classified in this way. For example, a table or a characteristic curve or map is used.

Alternatively, an artificial neural network may be used for the determination. For example, the classification of the current driving situation first also takes place based on the artificial neural network. Alternatively, the descriptors and the identifier are supplied to the artificial neural network as input variables, wherein the artificial neural network is designed and/or trained to output the target path deviation and/or the target speed deviation as output variable(s).

In summary, the determination of the target path deviation and/or the target speed deviation is carried out using an algorithm that represents, for example, the artificial neural network, the support vector machine, the decision tree, the assignment based on the table, based on the characteristic map or the characteristic curve. The descriptors and the identifier form the input variables for this algorithm, the target path deviation and/or the target speed deviation form the output variables of the algorithm. In further summary, the algorithm represents a model for determining the target path deviation and/or the target speed deviation.

In accordance with at least one embodiment of the method, the server determines the target path deviation and/or the target speed deviation. In comparison to a determination of the target path deviation and/or target speed deviation by the transportation vehicle, in particular by its driver assistance system, a computational effort in the transportation vehicle is, thus, reduced. Furthermore, the server can save and/or saves which value for the target path deviation and/or which value for the target speed deviation is assigned to the identifier and/or the current driving situation. The model for determining the target path deviation and/or the target speed deviation can, therefore, be stored on the server and/or is, therefore, stored on the server. This makes it possible for the driver to use this model with multiple vehicles based on their identifiers.

The value of the target path deviation and/or the value of the target speed deviation, which is assigned to the identifier and/or the current driving situation, can expediently be changed. For example, an initial value for the target path deviation and/or an initial value for the target speed deviation is predefined. In particular, the initial value for the target path deviation and/or the initial value for the target speed deviation is selected such that the target path corresponds to the swarm path and/or that the target speed corresponds to the swarm speed.

However, according to a suitable refinement of the method, the initial value for the target path deviation, i.e., the initial value for the target path deviation, and/or the initial value for the target speed deviation, i.e., the initial value for the speed deviation, is determined based on a driver input. The input is expediently carried out by an input device of the ego vehicle, such as a touch display, a switch, or a button.

For example, the driver fills out a questionnaire using the input device, wherein the initial value for the target path deviation and/or the initial value for the target speed deviation is determined based on the answers in a predefined manner, for example using a predefined table or characteristic curve. Alternatively, the driver selects one of several predefined driver profiles, such as “Comfort”, “Eco”, “Sport”, wherein the predefined driver profiles are assigned a predefined value for the target path deviation and/or a predefined value for the target speed deviation. For example, these driver profiles are additionally used to adjust a dynamic behavior of the drive of the transportation vehicle, such as a gear shifting behavior of a transmission and/or the strength of an acceleration.

In this way, a high initial degree of individualization for the automatic longitudinal and/or transverse guidance is optionally possible. This is optionally accompanied by an increase in the acceptance of driving using the driver assistance system.

According to at least one disclosed embodiment of the method, in the case of a manual drive, that is, during a manual drive, in other words, while the transportation vehicle is not automatically transversely and/or longitudinally guided, an actual speed (current speed) of the transportation vehicle and/or an actual path (current path) is determined. For example, the actual path is represented in an analogous manner to the paths of the swarm data sets by a distance to a lane marking on the road or to a roadside. Furthermore, an actual speed deviation of the actual speed from the swarm speed and/or an actual path deviation of the actual path from the swarm path is determined. Expediently, the actual speed deviation is the difference or ratio of the actual speed and the swarm speed. Expediently, the actual path deviation is the difference or ratio between the actual path and the swarm path.

The target path deviation and/or the target speed deviation is then set and/or changed for a future, i.e., for a subsequent, automatic longitudinal and/or transverse guidance, depending on the actual speed deviation and/or the actual path deviation. This adjustment and/or change expediently only takes place in a (future) driving situation that corresponds to the current driving situation.

The model and/or the method of determination and/or the value for the target path deviation and/or for the target speed deviation is, therefore, optionally adjusted, i.e., “trained”, based on the manual driving by the driver. Consequently, the automatic longitudinal and/or transverse guidance by the driver assistance system is optionally perceived as more pleasant.

According to at least one embodiment, during the current driving situation, the actual speed deviation and/or the actual path deviation is/are determined for successive time segments, each of which lasts for a predefined first duration. For example, the first duration is 0.1 s, 1.0 s, or 10 s. In summary, during the current driving situation the speed deviation and/or the actual path deviation are determined in the time segments of this driving situation.

Subsequently, a first adjustment factor for the target path deviation and/or for the target speed deviation is determined for a future, i.e., subsequent, longitudinal and/or transverse guidance based on the actual speed deviations of these time segments and/or based on the actual path deviations of these time segments. For example, only a predefined (first) number of the (temporally) last time segments may be used and/or the determination of the first adjustment factor is only carried out in response to there being a minimum number of such time segments.

For example, the first adjustment factor is an average of the actual speed deviations and/or the average actual speed deviation for the respective time segment, and/or an average of the actual path deviations and/or the average actual path deviation for the respective time segment.

The target path deviation and/or the target speed deviation is then adjusted, optionally, for a second duration using the first adjustment factor. In particular, the target path deviation and/or the target speed deviation is multiplied by the first adjustment factor. The adjustment using the first adjustment factor is, therefore, optionally, temporary, i.e., not permanent. In particular, the second duration is expediently longer than the first duration. For example, the second duration is 15 min, 1 h, 1 day, or until the end of the drive. When determining the target path and/or speed, the target path deviation and/or speed deviation is expediently multiplied by the first adjustment factor. This is accompanied by an increase or decrease in the target speed and/or the target path, for example. In summary, a short-term behavior or change in behavior of the driver is taken into account when determining the target course and/or speed.

Alternatively or in addition, the target path deviation and/or the target speed deviation is adjusted using a second adjustment factor. For example, the second adjustment factor is an average of the actual speed deviations and/or the average actual speed deviation for the respective time segment, and/or an average of the actual path deviations and/or the average actual path deviation for the respective time segment. A predefined second number of (temporally) last time segments is used, which is greater than the first number of time segments for determining the first adjustment factor. For example, the second number is 10 times, 100 times, or 1000 times greater than the first number.

When determining the target path and/or speed, the target path deviation and/or the speed deviation is expediently multiplied by the second adjustment factor. This is accompanied by an increase or decrease in the target speed and/or the target path, for example. The adjustment of the target path deviation and/or for the target speed deviation using the second adjustment factor is in particular permanent. In this way, the automatic longitudinal and/or transverse guidance can be adapted to the comparatively long-term behavior of the driver.

For example, it can be selected, in particular by the driver using the input device, whether only the first adjustment factor or only the second adjustment factor or a weighted first and second adjustment factor is to be used for adjusting the target path deviation and/or the target speed deviation.

According to at least one embodiment, the target path deviation and/or the speed deviation is increased or decreased for a predefined third duration in, i.e., during, an automatic longitudinal and/or transverse guidance. This change is accompanied by a corresponding change in the target path and target speed, as well as a correspondingly changed automatic longitudinal and/or transverse guidance. This change is, therefore, temporary, in other words not permanent and/or is automatically effected by the driver assistance system, i.e., not by the driver.

Furthermore, in response to the driver not manually intervening during the longitudinal and/or transverse guidance of the transportation vehicle within this duration, the target path deviation and/or the target speed deviation is increased or reduced for a future, i.e., subsequent, automatic longitudinal and/or transverse guidance. Thus, in response to the target path deviation having been increased during the third duration with no manual intervention being performed, the target path deviation for future automatic longitudinal and/or transverse guidance will be increased by a predefined amount. Thus, in response to the target path deviation having been reduced during the third duration with no manual intervention being performed, the target path deviation for future automatic longitudinal and/or transverse guidance will be reduced by a predefined amount. Thus, in response to the target speed deviation having been increased during the third duration with no manual intervention being performed, the target speed deviation for future automatic longitudinal and/or transverse guidance will be increased by a predefined amount. Thus, in response to the target speed deviation having been reduced during the third duration with no manual intervention being performed, the target speed deviation for future automatic longitudinal and/or transverse guidance will be reduced by a predefined amount.

A manual intervention is to be understood as manually aborting the automatic longitudinal and/or transverse guidance and/or performing a manual override, such as manual steering and/or manual acceleration.

In this way, the driver's behavior is evaluated whenever the path and/or vehicle speed are deliberately changed. In response to an intervention having been made, the target path deviation and/or the target speed deviation is expediently not changed, as it can then be assumed that the driver does not agree with this change. In response to the driver not intervening manually, it may be assumed that the target path deviation and/or the target speed deviation is still perceived as pleasant. This specific change allows the target path deviation and/or target speed deviation to be automatically adjusted to the behavior desired by the driver.

According to a suitable refinement, in addition to or alternatively, in the case of automatic longitudinal and/or transverse guidance, the target speed deviation for future automatic longitudinal guidance may be increased in the event of a manual intervention by the driver, in response to the manual intervention involving an increase in the vehicle speed. Furthermore, the target speed deviation for future automatic longitudinal guidance may be suitably reduced in response to the manual intervention including a reduction in the vehicle speed. Furthermore, the target path deviation for a future automatic transverse guidance may be suitably changed such that the transportation vehicle moves further to the left in response to the manual intervention includes steering to the left. Furthermore, the target path deviation for a future automatic transverse guidance may be suitably changed such that the transportation vehicle moves further to the right in response to the manual intervention including steering to the right.

A further aspect of the disclosed embodiments relates to such a system. The system, therefore, includes the vehicle and the server. In this case, the transportation vehicle and the server have means for carrying out the method in one of the variants shown above. In particular, the transportation vehicle and the server each comprise a control unit (controller) as the means. For example, the driver assistance system of the transportation vehicle may be or includes its control unit.

Expediently, the server includes a computer-readable medium connected to its control unit for data transfer, for example a hard disk, on which the swarm data are stored. Furthermore, a computer program may be expediently stored on the computer-readable medium of the server and on a computer-readable medium of the transportation vehicle, for example, an additional hard disk, each of the computer programs comprising commands that cause the system to carry out the operations of the method.

Equivalent parts and dimensions are provided with identical reference numerals in all figures.

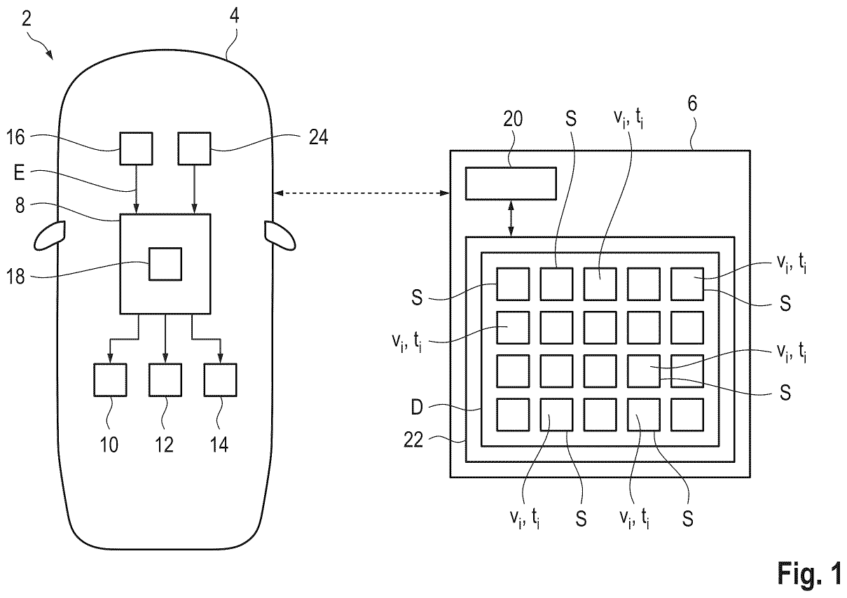

FIG. 1 shows a system 2 which includes a transportation vehicle 4 and a server 6 external thereto. The transportation vehicle 4 may be connected and/or connected to the server 6 for signal and/or data transmission.

The transportation vehicle 4 includes a driver assistance system 8. This may be intended and configured to automatically guide the transportation vehicle 4 longitudinally and/or transversely. For this purpose, the driver assistance system 8 may be connected to a drive 10, a brake 12 and/or a steering 14 of the transportation vehicle 4 and can control the drive 10, the brake 12 and/or the steering 14.

The transportation vehicle 4 also includes an input device 16, such as a button, a lever or a touch display, so that a user of the transportation vehicle 4 can enter an input E. The input device 16 may be connected to a (first) control unit 18 of the transportation vehicle 4 for signal and/or data transmission. The control unit 18 is or expediently includes a controller. This may be integrated in the driver assistance system 8 according to the embodiment shown here. Alternatively, the first control unit 18 may be separate from the driver assistance system 8, but may be connected thereto for signal and/or data transmission.

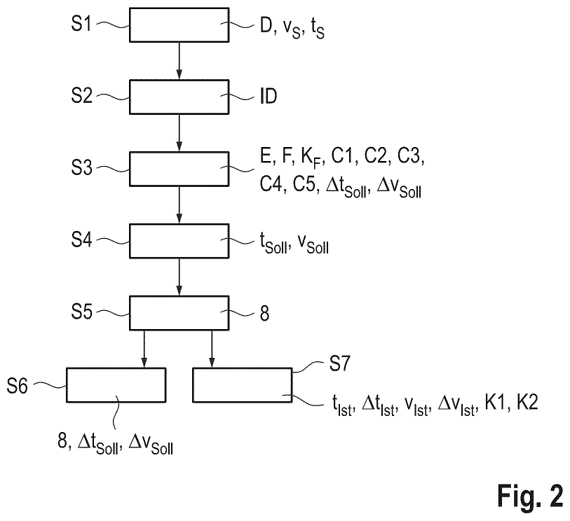

The server 6 includes a (second) control unit 20, which may be designed in particular as a controller. In this case, the transportation vehicle 4, in particular its first control unit 18, can be or is connected for data transmission to the server 6, in particular its second control unit 20, which is represented in FIG. 1 with the double arrow shown by a dashed line. The two control units 18, 20 form means via which the system 2 according to the method described in FIG. 2 can be and/or is operated.

Furthermore, the server 6 includes a computer-readable medium 22 (memory 22) connected to its control unit 20, for example a non-volatile memory such as a hard disk. Swarm data D may be stored on the computer-readable medium 22. Thus, swarm data D may be provided on the server 6. The swarm data D comprise data sets S, in particular a plurality of data sets S, of which only 20 is shown in FIG. 1 for better clarity. Each of the data sets S represents a path ti assigned to the current location of the transportation vehicle 4 and a speed vi assigned to the current location of the transportation vehicle 4.

Each of these paths ti, therefore, represents a path previously driven at the location of the transportation vehicle 4 by the transportation vehicle 4 or by another transportation vehicle. For example, the respective path ti may be represented by a distance from a lane marking on the road or from a roadside. For example, each path may be represented by a variable, in particular a number.

Each of these speeds vi, therefore, represents a (vehicle) speed of the transportation vehicle 4 or of another transportation vehicle when driven at the location of the transportation vehicle 4. For example, each path may be represented by a variable, in particular a number.

FIG. 2 shows a method for operating the system 2, based on a flow diagram. In a first operation S1, the current location of the transportation vehicle 4 may be determined. For example, the current location may be determined using a navigation system 24 of the transportation vehicle 4 and/or using a GPS system of the transportation vehicle 4 and data about the location of the transportation vehicle 2 may be transmitted to the server 6.

Subsequently, in the first operation S1, using the server 6, in particular using its second control unit 20, and those data sets S of the swarm data D assigned to the current location of the transportation vehicle 4, a so-called swarm path tS and a so-called swarm speed vS are determined. For this purpose, the average value of the speeds vi of these data sets S may be determined as the swarm speed vS and the mean value of the paths ti of these data sets S may be determined as the swarm path tS.

In a second operation S2, which takes place temporally before, after or during the first operation S1, an identifier ID, in particular an identification number, of the driver of the transportation vehicle 4 may be determined using the driver assistance system 8. The identifier ID may be designed such that it may be uniquely assigned only to this driver. In particular, each driver may be assigned an individual and unique identifier. To determine the identifier ID, the driver may be recognized, for example, based on facial recognition, a driver input, their fingerprint, their transportation vehicle key and/or using their mobile phone and the identifier ID may be assigned to the recognized driver.

In a third operation S3, depending on the identifier ID, a target path deviation ΔtSoll from the swarm path tS may be determined and/or a target speed deviation ΔvSoll from the swarm speed vS may be determined. The target path deviation ΔtSoll, therefore, represents a target value for a value (i.e., its amount and its sign) of a deviation from the swarm path tS or a factor for the swarm path tS. Alternatively or in addition, the speed deviation ΔvSoll represents a target value for a value of a deviation from the swarm speed vS or a factor for the swarm speed vS.

For this purpose, a descriptor C1 of the transportation vehicle 4, a descriptor C2 of the vehicle environment, a descriptor C3 of the driver, a descriptor C4 of a planned or currently driven route, and/or a descriptor C5 of the road may be determined. These descriptors C1, C2, C3, C4 and/or C5 are, for example, each predefined or can be predefined by an input from the driver on the input device 16. Alternatively, the descriptors are determined based on sensor data of a sensor of the transportation vehicle 4. For example, image data of an external camera of the motor vehicle 4 may be evaluated to determine a property of the vehicle environment and/or the road as the respective descriptor C2 or C5.

The identifier ID, and descriptors C1, C2, C3, C4, and/or C5 are transmitted to the server 6. On the server 6, in particular on its computer-readable medium 22, a model may be stored, which may be provided and configured for determining the target path deviation ΔvSoll and/or the speed deviation ΔtSoll.

Based on the server 6, a current driving situation F may be first determined using the descriptors C1, C2, C3, C4 and/or C5 for determining the target path deviation ΔtSoll and/or the speed deviation ΔvSoll. For this purpose, a characteristic curve or a map may be used, which assigns a (driving situation) class F from a number of predefined classes K to one of the descriptors or descriptor C1, C2, C3, C4 and/or C5. Alternatively, a support vector machine may be used for the classification, and, thus, for the assignment of the class KF to one of the descriptors or to descriptor C1, C2, C3, C4 and/or C5.

In a further alternative, a decision tree may be used for the classification, and, thus, for the assignment of the class KF to one of the descriptors or to descriptor C1, C2, C3, C4 and/or C5.

Alternatively, an artificial neural network may be used for the classification, and, thus, for the assignment of the class KF to one of the descriptors or to descriptor C1, C2, C3, C4 and/or C5.

The model may be or includes the characteristic curve, the characteristic map, the support vector machine, the decision tree or the artificial neural network.

In summary, the current driving situation F may be classified, i.e., assigned to a class KF of several predefined classes K which represent different driving situations.

The value (i.e., its amount and its sign) of the target path deviation ΔtSoll and/or the value of the target speed deviation ΔvSoll may be then assigned to the class KF determined during the classification. The target path deviation ΔtSoll value assigned to this class K F and/or the target speed deviation ΔvSoll value assigned to this class KF depends on the identifier ID. For example, in a table it may be predefined which class KF corresponds to the current driving situation and which the value of the target speed deviation ΔvSoll and/or the value of the target path deviation ΔtSoll may be assigned depending on the identifier ID.

The value of the target speed deviation ΔvSoll and/or the value of the target path deviation ΔtSoll, which may be determined depending on the identifier ID and the class KF assigned to the current driving situation F, can be changed and/or specified.

The initial value of the target speed deviation ΔvSoll and/or the initial value of the target path deviation ΔtSoll may be respectively predefined or may be optionally determined based on an input E of the driver at the input device 16, wherein the driver selects one of several input options. For example, for each input option, the initial value of the target speed deviation ΔvSoll and/or the initial value of the target path deviation ΔtSoll may be predetermined, so that the initial value of the target speed deviation ΔtSoll and/or the initial value of the target path deviation ΔvSoll may be selected according to the input E.

Alternatively, the target path deviation ΔtSoll and/or the speed deviation ΔvSoll may be calculated directly based on the model, which may be designed as an artificial neural network, for example.

According to an alternative not further illustrated, the target path deviation ΔtSoll and/or the target speed deviation ΔvSoll may be determined analogously using descriptors C1, C2, C3, C4 and/or C5 and using the identifier ID by the driver assistance system 8, in particular its control unit 18.

In summary, the target path deviation ΔtSoll and/or the target speed deviation ΔvSoll may be determined depending on the current driving situation F and the identifier ID.

Subsequently, in a fourth operation S4, a target path tSoll for the transportation vehicle 4 may be determined based on the server 6, the target path deviation ΔtSoll and the swarm path tS, and/or a target speed vSoll for the transportation vehicle 4 may be determined based on the server 6, the target speed deviation ΔvSoll and the swarm speed vS. For example, the target path deviation ΔtSoll and the swarm path tS are added together and/or the target speed deviation ΔvSoll and the swarm speed vS are added together.

The target path tSoll and/or the target speed vSoll may be transmitted to the transportation vehicle 4, in particular to its driver assistance system 8.

According to an alternative embodiment, not further illustrated, the target path tSoll and/or the target speed vSoll may be determined in an analogous manner by the driver assistance system 8, in particular its control unit 18.

Subsequently, in a fifth operation S5, the transportation vehicle 4 may be automatically guided longitudinally and/or transversely depending on the target speed vSoll and/or depending on the target path tSoll using a driver assistance system (8). In particular, the speed of the transportation vehicle 4 may be regulated using the driver assistance system 8 such that it corresponds to the target speed vSoll. Alternatively or in addition, the path and/or a lateral position of the transportation vehicle 4 may be regulated using the driver assistance system 8 such that it corresponds to the target path tSoll.

Optionally, in a subsequent sixth operation S6, while the transportation vehicle 4 may be being automatically guided longitudinally and/or transversely using the driver assistance system 8, the target path deviation ΔtSoll and/or the target speed deviation ΔvSoll is/are increased or reduced for a predefined third duration. This change may be made automatically by the driver assistance system 8 and may not be based on an intervention or input by the driver.

If during this third duration the driver does not manually intervene during the longitudinal and/or transverse guidance, the target path deviation ΔtSoll and/or the target speed deviation ΔvSoll may be increased (if this has been automatically increased by the driver assistance system 8) or decreased, i.e., reduced (if this has been automatically reduced by the driver assistance system 8) for future automatic longitudinal and/or transverse guidance. In summary, the value for the target path deviation ΔtSoll and/or the value for the target speed deviation ΔvSoll may be changed and used for future automatic longitudinal and/or transverse guidance.

Optionally and in addition to or as an alternative to the sixth operation S6, in a seventh operation S7, an actual speed vIst of the transportation vehicle 4 and/or an actual path tIst and optionally the current driving situation FIst may be determined during manual driving. Furthermore, an actual speed deviation ΔvIst of the actual speed vIst from the swarm speed vS and/or an actual path deviation ΔtIst of the actual path tIst from the swarm path tS may be determined. For example, the ratio of the actual speed vIst and the swarm speed vS may be used as the actual speed deviation ΔvIst. For example, the ratio of the actual path tIst and the swarm path tS may be used as the actual path deviation ΔtIst.

The target path deviation ΔtSoll and/or the target speed deviation ΔvSoll for future automatic longitudinal and/or transverse guidance may be set and/or changed depending on the actual speed deviation ΔtIst and/or the actual path deviation ΔvIst, in particular only, in response to the future driving situation, in which automatic longitudinal and/or transverse guidance will be used in the future, corresponding to the current driving situation F. For example, during the current driving situation F, the actual speed deviation ΔvIst and/or the actual path deviation ΔtIst is/are determined for successive time segments, each of which lasts for a predefined first duration. A first adjustment factor K1 for the target path deviation ΔtSoll and/or for the target speed deviation ΔvSoll may be determined based on these actual speed deviations ΔvIst and/or based on these actual path deviations ΔtIst—for example by averaging the actual speed deviations ΔvIst or the actual path deviations ΔtIst. To determine the first adjustment factor K1, a predefined first number of the (temporally) most recent time segments may be used.

When determining the target path tSoll and/or the target speed vSoll, the target path deviation ΔtSoll and/or the target speed deviation ΔvSoll may be multiplied by the first adjustment factor K1. Such a determination of the target path tSoll and/or the target speed vSoll may be only carried out for a second duration, i.e., only temporarily. Thus, the target path deviation ΔtSoll and/or the target speed deviation ΔvSoll may be only adjusted for the second duration using the first adjustment factor K1.

For example, the first duration may be 0.1 s, 1.0 s, or 10 s, for example, the second duration may be 15 min, 1 h, 1 day, or until the end of the drive.

Alternatively or in addition, the target path deviation ΔtSoll and/or the target speed deviation ΔvSoll may be adjusted using a second adjustment factor K2, which may be based on a second number of actual speed deviations ΔvIst and/or actual path deviations ΔtIst of the (temporally) last time segments. The second number may be greater than the first number. In summary, more actual speed deviations ΔvIst and/or more actual path deviations ΔtIst are used for determining the second adjustment factor K2 than for determining the first adjustment factor K1. In an analogous manner to determining the first adaptation factor K1, determining the second adaptation factor K2 may be carried out, for example, by averaging these actual speed deviations ΔvIst and/or these actual path deviations ΔtIst.

When determining the target path tSoll and/or the target speed vSoll, the target path deviation ΔtSoll and/or the target speed deviation ΔvSoll may be multiplied by the second adjustment factor K1.

Disclosed embodiments are not limited to the exemplary embodiments described above. Instead, other variants can also be derived from within the claims by the person skilled in the art, without departing from the subject-matter of the disclosed embodiments. In particular, all individual features described in connection with the exemplary embodiments and/or in the claims can also be combined together in different ways without departing from the subject matter of the disclosed embodiments.

### LIST OF REFERENCE SIGNS

2 system
4 transportation vehicle
6 server
8 driver assistance system
10 drive
12 brake
14 steering
16 input device
18 transportation vehicle control unit
20 server control unit
22 computer-readable medium
24 navigation system
C1 to C5 descriptor
D swarm data
E input
F current driving situation
K1 first adjustment factor
K2 second adjustment factor
K_{F} class
ID identifier
S data set
tᵢ path
t_{Ist} actual path
t_{S} swarm path
t_{Soll} target path
vᵢ speed
v_{Ist} actual speed
v_{S} swarm speed
v_{Soll} target speed
Δt_{Ist} actual path deviation
Δt_{Soll} target path deviation
Δv_{Ist} actual speed deviation
Δv_{Soll} target speed deviation
S1 determining the swarm path and the swarm speed
S2 determining the identifier
S3 determining the target path deviation and/or the target speed deviation
S4 determining the target path and/or target speed
S5 automatic longitudinal and/or transverse guidance
S6 automatic changing of the target path deviation and/or the target speed deviation
S7 determining adaptation factors

1. A method for operating a system including a transportation vehicle and a server, the method comprising:
providing swarm data including data sets provided on the server, each data set representing a path associated with a transportation vehicle current location, and a speed associated with the transportation vehicle current location;
determining a swarm path and a swarm speed based on the swarm data;
determining an identifier associated with the driver of the transportation vehicle;
determining, depending on the identifier, a target path deviation relative to the swarm path and/or a target speed deviation relative to the swarm speed;
at least one of determining a target path for the transportation vehicle based on the target path deviation and of the swarm path and determining a target speed for the transportation vehicle based on the target speed deviation and of the swarm speed; and
automatically guiding the transportation vehicle longitudinally and/or transversely depending on the target speed and/or the target path using a driver assistance system.

2. The method of claim 1, further comprising determining the current driving situation, and determining whether the target path deviation and/or the target speed deviation depending on the current driving situation.

3. The method of claim 2, wherein the current driving situation is determined using a descriptor of the transportation vehicle, a descriptor of the vehicle environment, a descriptor of the driver, a descriptor of a planned or currently driven route, and/or a descriptor of the road.

4. The method of claim 2, wherein the current driving situation is classified to determine the target path deviation and/or the target speed deviation, and wherein a value for the target path deviation and/or a value for the target speed deviation is assigned to a class determined during the classification, wherein the target path deviation value assigned to this class and/or the target speed deviation value assigned to this class depends on the identifier.

5. The method of claim 1, wherein an initial value for the target path deviation and/or an initial value for the target speed deviation is/are determined based on an input from the driver.

6. The method of claim 1, wherein:
an actual speed of the transportation vehicle and/or an actual path is determined during manual driving,
an actual speed deviation of the actual speed from the swarm speed and/or an actual path deviation of the actual path relative to the swarm path is/are determined, and
the target path deviation and/or the target speed deviation is set and/or changed for future automatic longitudinal and/or transverse guidance as a function of the actual speed deviation and/or the actual path deviation.

7. The method of claim 2, wherein:
during the current driving situation, the actual speed deviation and/or the actual path deviation is/are determined for successive time segments, each of which lasts for a predefined first duration,
a first adjustment factor is determined for the target path deviation and/or for the target speed deviation based on the actual speed deviations and/or based on the actual path deviations,
the target path deviation and/or the target speed deviation is adjusted only for a second duration based on the first adjustment factor, and/or
the target path deviation and/or the target speed deviation is/are adjusted based on a second adjustment factor, which is determined based on a number of actual speed deviations and/or actual path deviations, which is greater than a number of actual speed deviations and/or actual path deviations for determining the first adjustment factor.

8. The method of claim 1, wherein:
during automatic longitudinal and/or transverse guidance, the target path deviation and/or the target speed deviation is/are increased or reduced for a predefined third duration, and
in response to the driver not manually intervening during the longitudinal and/or transverse guidance within this duration, the target path deviation and/or the target speed deviation is/are increased or decreased for a future automatic longitudinal and/or transverse guidance.

9. The method of claim 1, wherein the server determines the target path deviation and/or the target speed deviation.

10. A system comprising:
a transportation vehicle;
a server;
a transportation vehicle control unit; and
a server control unit,
wherein the transportation vehicle control unit and the server control unit cooperate to:
provide swarm data including data sets provided on the server, each data set representing a path associated with a transportation vehicle current location, and a speed associated with the transportation vehicle current location;
determine a swarm path and a swarm speed based on the swarm data;
determine an identifier associated with the driver of the transportation vehicle;
determine, depending on the identifier, a target path deviation relative to the swarm path and/or a target speed deviation relative to the swarm speed;
determine a target path for the transportation vehicle based on the target path deviation and of the swarm path and/or determine a target speed for the transportation vehicle based on the target speed deviation and of the swarm speed; and
automatic guidance of the transportation vehicle longitudinally and/or transversely depending on the target speed and/or the target path using a driver assistance system.

11. The system of claim 10, wherein the transportation vehicle control unit and the server control unit cooperate to determine the current driving situation, and determine whether the target path deviation and/or the target speed deviation depending on the current driving situation.

12. The system of claim 11, wherein the current driving situation is determined using a descriptor of the transportation vehicle, a descriptor of the vehicle environment, a descriptor of the driver, a descriptor of a planned or currently driven route, and/or a descriptor of the road.

13. The system of claim 11, wherein the current driving situation is classified to determine the target path deviation and/or the target speed deviation, and wherein a value for the target path deviation and/or a value for the target speed deviation is assigned to a class determined during the classification, wherein the target path deviation value assigned to this class and/or the target speed deviation value assigned to this class depends on the identifier.

14. The system of claim 10, wherein an initial value for the target path deviation and/or an initial value for the target speed deviation is/are determined based on an input from the driver.

15. The system of claim 10, wherein:
an actual speed of the transportation vehicle and/or an actual path is determined during manual driving,
an actual speed deviation of the actual speed from the swarm speed and/or an actual path deviation of the actual path relative to the swarm pathis/are determined, and
the target path deviation and/or the target speed deviation is set and/or changed for future automatic longitudinal and/or transverse guidance as a function of the actual speed deviation and/or the actual path deviation.

16. The system of claim 11, wherein:
during the current driving situation, the actual speed deviation and/or the actual path deviation is/are determined for successive time segments, each of which lasts for a predefined first duration,
a first adjustment factor is determined for the target path deviation and/or for the target speed deviation based on the actual speed deviations and/or based on the actual path deviations,
the target path deviation and/or the target speed deviation is adjusted only for a second duration based on the first adjustment factor, and/or
the target path deviation and/or the target speed deviation is/are adjusted based on a second adjustment factor, which is determined based on a number of actual speed deviations and/or actual path deviations, which is greater than a number of actual speed deviations and/or actual path deviations for determining the first adjustment factor.

17. The system of claim 10, wherein:
during automatic longitudinal and/or transverse guidance, the target path deviation and/or the target speed deviation is/are increased or reduced for a predefined third duration, and
in response to the driver not manually intervening during the longitudinal and/or transverse guidance within this duration, the target path deviation and/or the target speed deviation is/are increased or decreased for a future automatic longitudinal and/or transverse guidance.

18. The system of claim 10, wherein the server determines the target path deviation and/or the target speed deviation.
